(19) United States
(12) Patent Application Publication
(10) Pub. No.: US 2019/0285005 A1
(43) Pub. Date: Sep. 19, 2019

(54) VARIABLE SYSTEM OF INTERNAL COMBUSTION ENGINE AND METHOD FOR CONTROLLING THE SAME

(71) Applicant: HITACHI AUTOMOTIVE SYSTEMS, LTD., Hitachinaka-shi, Ibaraki (JP)

(72) Inventor: Makoto NAKAMURA, Zushi-shi, Kanagawa (JP)

(73) Assignee: HITACHI AUTOMOTIVE SYSTEMS, LTD., Hitachinaka-shi, Ibaraki (JP)

(21) Appl. No.: 16/349,218

(22) PCT Filed: Nov. 1, 2017
(86) PCT No.: PCT/JP2017/039506

§ 371 Date: May 10, 2019

(30) Foreign Application Priority Data
Nov. 15, 2016 (JP) 2016-222180

(51) Int. Cl. F02D 13/02; F02B 37/18; F02D 15/02; F01L 13/00; F02B 75/04

(52) U.S. Cl. CPC F02D 13/0226; F02B 37/18; F02D 15/02; F01L 2013/0084; F02B 75/045; F02D 2200/1002; F01L 13/0015

(57) ABSTRACT

A variable system of an internal combustion engine spaces a closing timing IVC of an intake valve apart from an intake bottom dead center BDC by a variable actuation valve mechanism and also increases a mechanical expansion ratio εE by a variable compression ratio mechanism when an engine torque increases to around a maximum engine torque. The variable system sets the closing timing IVC of the intake valve to a closing timing IVCd spaced apart from the intake bottom dead center BDC around the maximum engine torque. Due to this control, the variable system can reduce an effective compression ratio to enhance a knocking resistance capability, and, further, achieve improvement of thermal efficiency and also reduce a temperature of exhaust gas to prevent or reduce thermal damage on an exhaust-system component by increasing the mechanical expansion ratio.

### TECHNICAL FIELD

The present invention relates to a variable system of an internal combustion engine, in particular, to a variable system of an internal combustion engine including a variable compression ratio mechanism that controls a mechanical compression ratio in a four-cycle internal combustion engine and a variable actuation valve mechanism that controls a valve timing, and a method for controlling the variable system of the internal combustion engine.

### BACKGROUND ART

For internal combustion engines relating to this kind of field, there is proposed improving an operational performance of the internal combustion engine by combining a variable compression ratio mechanism that variably controls a geometric compression ratio, i.e., a mechanical compression ratio of the internal combustion engine, and a variable actuation valve mechanism that variably controls opening/closing timings of an intake valve and an exhaust valve, which determine an actual compression ratio. For example, an internal combustion engine discussed in Japanese Patent Application Public Disclosure No. 2002-276446 (PTL 1) includes a variable actuation valve mechanism that variably controls a closing timing of an intake valve of an internal combustion engine, and a variable compression ratio mechanism that variably controls a mechanical compression ratio of the internal combustion engine by changing a piston position so as to reduce the mechanical compression ratio according to an increase in a load.

Then, the internal combustion engine is configured to be able to acquire a decompression function of reducing compression during cranking by reducing an actual compression ratio even when the mechanical compression ratio is increased, by setting the closing timing of the intake valve during the cranking to a timing spaced apart from an intake bottom dead center and placing the closing timing of the intake valve closer to the intake bottom dead center after a start of the cranking with use of the variable actuation valve mechanism while keeping the mechanical compression ratio at a high compression ratio equivalent to during idling, for example, when the engine is started up. Therefore, this technique allows the internal combustion engine to increase the number of cranking rotations, and, further, allows the internal combustion engine to increase the actual compression ratio and achieve an increase in a temperature of an air-fuel mixture by placing the closing timing of the intake valve closer to the intake bottom dead center after the start of the cranking.

Besides that, there are also other attempts to improve the operational performance of the internal combustion engine with use of the variable actuation valve mechanism that variably controls the closing timing of the intake valve and the variable compression ratio mechanism that variably controls the mechanical compression ratio, but a further description thereof will be omitted herein.

### CITATION LIST

### Patent Literature

[PTL 1] Japanese Patent Application Public Disclosure No. 2002-276446

### SUMMARY OF INVENTION

### Technical Problem

Then, there is proposed control that reduces the mechanical compression ratio as an engine torque increases with use of the variable compression ratio mechanism, besides PTL 1. This is because an aim thereof is to achieve an increase in a maximum engine torque by advancing an ignition timing after improving a knocking resistance capability by reducing the mechanical compression ratio. This control can improve the knocking resistance capability without increasing fuel (increasing latent heat of vaporization), thereby being expected to bring about an effect of improving fuel economy.

However, this method can improve the knocking resistance capability, but, on the other hand, also leads to a reduction in a mechanical expansion ratio along with the reduction in the mechanical compression ratio, thereby newly raising a problem of facilitating occurrence of thermal damage on an exhaust-system component (an exhaust pipe, a catalyst for purifying exhaust gas, and the like) around the maximum engine torque (load) because a temperature of the exhaust gas also increases, as well as thermal efficiency reduces and thus the fuel economy is deteriorated.

An object of the present invention is to provide a novel variable system of an internal combustion engine capable of preventing or reducing the deterioration of the fuel economy and further preventing or reducing the thermal damage on the exhaust-system component when the engine torque increases to around the maximum engine torque, and a method for controlling this variable system of the internal combustion engine.

### Solution to Problem

According to one aspect of the present invention, a variable system of an internal combustion engine is configured to set a closing timing of an intake valve to a closing timing spaced apart from an intake bottom dead center by a variable actuation valve mechanism and also increase a mechanical expansion ratio by a variable compression ratio mechanism when an engine torque increases to around a maximum engine torque. As will be used herein, “spaced apart” means shifting the closing timing of the intake valve toward a retard-angle side or an advance-angle side with respect to the intake bottom dead center.

According to the one aspect of the present invention, the variable system becomes able to reduce an effective compression ratio to enhance the knocking resistance capability by spacing the closing timing of the intake valve apart from the intake bottom dead center, and, further, achieve improvement of the thermal efficiency (=improvement of the fuel economy) and also reduce the temperature of the exhaust gas to prevent or reduce the thermal damage on the exhaust-system component by increasing the mechanical expansion ratio, around the maximum engine torque.

### BRIEF DESCRIPTION OF DRAWINGS

FIG. 1 is an overall schematic view of a variable system of an internal combustion engine according to the present invention.

FIG. 2 is an overall perspective view of a variable actuation valve mechanism used in the present invention.

FIG. 3 illustrates a lift characteristic of an intake valve by the variable actuation valve mechanism.

FIG. 4A is a configuration diagram illustrating a configuration of a variable compression ratio mechanism used in the present invention and indicating a state thereof controlled to a minimum mechanical compression ratio.

FIG. 4B is a configuration diagram illustrating the configuration of the variable compression ratio mechanism used in the present invention and indicating a state thereof controlled to a maximum mechanical compression ratio.

FIG. 5 illustrates a control characteristic of a variable system according to a first embodiment of the present invention.

FIGS. 6(a) to 6(e) are each a characteristic diagram for facilitating understanding of the control characteristic illustrated in FIG. 5 in further details.

FIGS. 7(a) to 7(d) are each a valve characteristic diagram for facilitating further understanding of the control characteristic illustrated in FIGS. 6(a) to 6(e).

FIG. 8 is a control flowchart that performs control of the variable system according to the first embodiment.

FIG. 9 is a control flowchart that performs control of a variable system according to a second embodiment of the present invention.

FIGS. 10(a) to 10(d) are each a valve characteristic diagram for facilitating understanding of a control characteristic of a variable system according to a third embodiment of the present invention.

FIG. 11 is a configuration diagram indicating a configuration of a variable compression ratio mechanism used in a variable system according to a fourth embodiment of the present invention.

FIGS. 12(a) to 12(e) are each a characteristic diagram for facilitating understanding of a control characteristic of the variable system according to the fourth embodiment.

### DESCRIPTION OF EMBODIMENTS

In the following description, embodiments of the present invention will be described in detail with reference to the drawings, but the present invention is not limited to the embodiments that will be described below and a range thereof also includes various modification examples and application examples within a technical concept of the present invention.

### First Embodiment

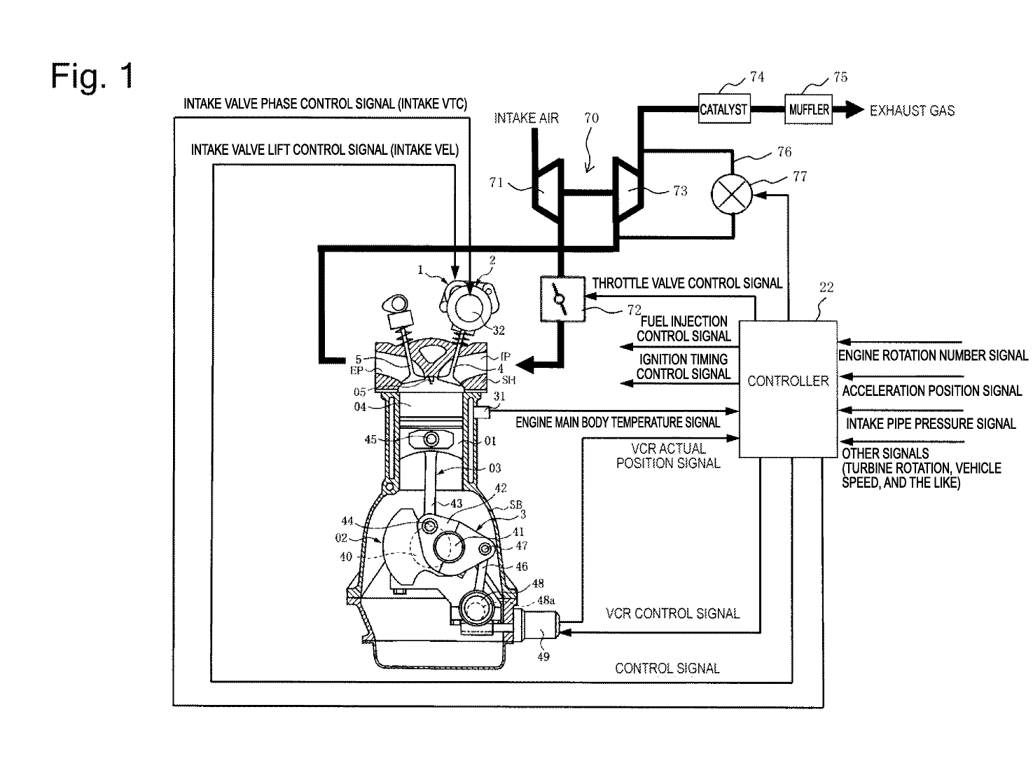

A variable system of an internal combustion engine according to a first embodiment of the present invention will be described, and FIG. 1 illustrates an overall configuration of the variable system of the internal combustion engine to which the present invention is applied.

First, a basic configuration of the variable system of the internal combustion engine will be described with reference to FIG. 1. The variable system of the internal combustion engine includes a piston 01, an intake port IP and an exhaust port EP, and a pair of intake valve 4 and exhaust valve 5 for each one of cylinders. The piston 01 is provided vertically slidably due to, for example, a combustion pressure in a cylinder bore formed in a cylinder block SB. The intake port IP and the exhaust port EP are each formed inside a cylinder head SH. The pair of intake valve 4 and exhaust valve 5 is provided slidably in the cylinder head SH, and opens and closes opening ends of the intake and exhaust ports IP and EP.

The piston 01 is coupled with a crankshaft 02 via a connecting rod 03 including a lower link 42 and an upper link 43, which will be described below, and also defines a combustion chamber 04 between a crown surface thereof and a bottom surface of the cylinder head SH. Further, an ignition plug 05 is provided approximately at a center of the cylinder head SH.

The intake port IP is connected to a not-illustrated air cleaner, and intake air is supplied from a compressor 71 of a turbocharger 70, which is a supercharger, via an electrically controllable throttle valve 72. The electrically controllable throttle valve 72 is controlled by a controller 22, and is configured in such a manner that an opening degree thereof is basically controlled according to how much an accelerator pedal is pressed.

Further, the exhaust port EP releases exhaust gas to the atmosphere via an exhaust gas purification catalyst 74 and a muffler 75 through a turbine 73 of the turbocharger 70. Now, an upstream side and a downstream side of the turbine 73 are connected to each other via an exhaust bypass passage 76, and an electrically controllable waste gate valve 77 is disposed on the way of the exhaust bypass passage 76. This electrically controllable waste gate valve 77 functions to adjust an amount of the exhaust gas flowing into the turbine 73, and a boost pressure of the compressor 71 is adjusted thereby.

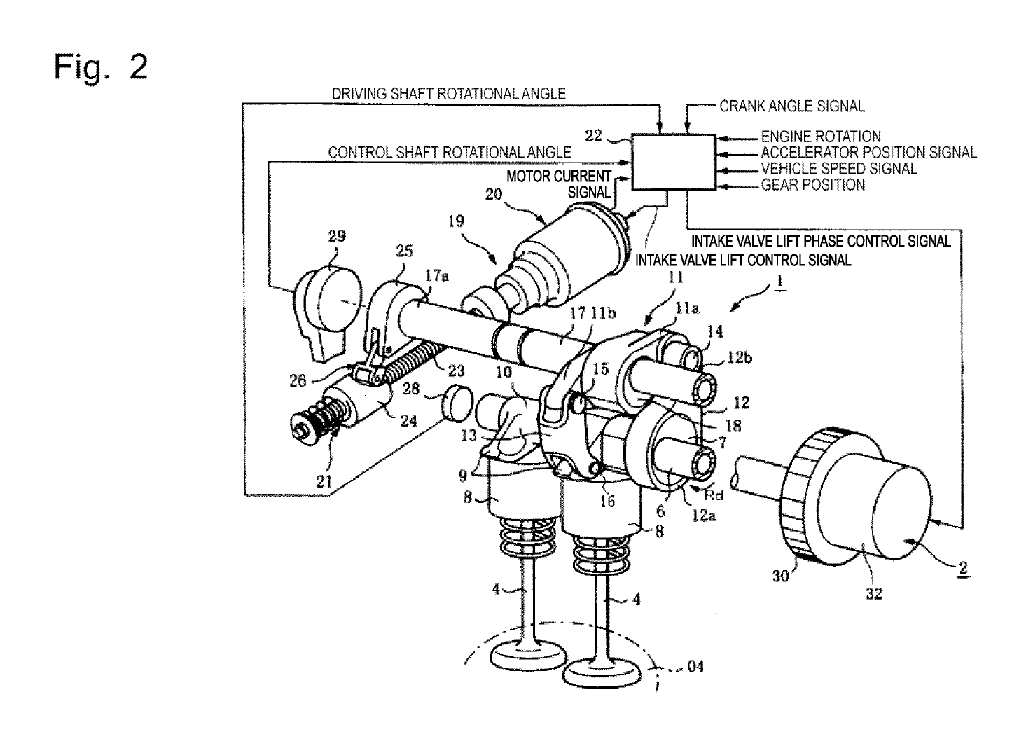

Further, a first variable actuation valve mechanism (an intake VEL) 1, a second variable actuation valve mechanism (an intake VTC) 2, and a variable compression ratio mechanism (VCR) 3 are provided in this internal combustion engine as illustrated in FIGS. 1 and 2. The first variable actuation valve mechanism 1 serves as a “lift/actuation angle variable mechanism” that controls a valve lift and an actuation angle (an opening period) of the intake valve 4. The second variable actuation valve mechanism 2 serves a “phase angle variable mechanism” that controls a central phase angle of the valve lift of the intake valve 4. The variable compression ratio mechanism 3 serves as a “piston stroke variable mechanism” that controls a mechanical compression ratio εC (the same as a mechanism expansion ratio εE) in the cylinder.

The first variable actuation valve mechanism 1 is configured as an intake valve closing timing variable mechanism that controls the valve lift and the actuation angle (an opening period) of the intake valve 4, thereby changing a closing timing of the intake valve 4 to change an effective compression ratio. A specific structure thereof is similar to, for example, a structure discussed in “Japanese Patent Application Public Disclosure No. 2003-172112” previously applied by the present applicant.

An outline thereof will be described with reference to FIG. 2. The first variable actuation valve mechanism 1 includes a hollow driving shaft 6, a driving cam 7, two swingable cams 9, and a transmission mechanism. The driving shaft 6 is rotatably supported by a bearing above the cylinder head SH. The driving cam 7 is an eccentric rotational cam fixedly provided by, for example, being press-fitted to an outer peripheral surface of the driving shaft 6. The swingable cams 9 are swingably supported on the outer peripheral surface of the driving shaft 6, and each actuate the intake valve 4 to open it in slidable contact with a top surface of a valve lifter 8 arranged on an upper end portion of the intake valve 4. The transmission mechanism is disposed between the driving cam 7 and the swingable cams 9, and converts a rotational force of the driving cam 7 into a swinging movement and transmits it to the swingable cams 9 as a swinging force.

A rotational force is transmitted to the driving shaft 6 from the crankshaft 02 through a not-illustrated timing chain via a timing sprocket 30 provided at one end portion thereof, and a direction of this rotation is set to a direction indicated by an arrow Rd in FIG. 2. The driving cam 7 has a generally ring shape, and fixedly penetrates through the driving shaft 6 via an internally axially formed driving shaft insertion hole and also has a central axis of a cam main body that is radially offset from a central axis of the driving shaft 6 by a predetermined amount.

As illustrated in FIG. 2, the swinging cams 9 have identical and generally raindrop-like shapes and are provided integrally at both end portions of an annular cam shaft 10, and the cam shaft 10 is also rotatably supported on the driving shaft 6 via an inner peripheral surface thereof. Further, a cam surface is formed on a bottom surface, and a base circle surface, a ramp surface, and a lift surface are formed. The base circle surface is located on one side closer to a shaft of the cam shaft 10. The ramp surface extends from this base circle surface toward a cam nose portion side in a circular-arc manner. The lift surface extends from this ramp surface to be connected to a top surface of a maximum lift that is provided at a distal end side of the cam nose portion. The base circle surface, the ramp surface, and the lift surface are configured to abut against a predetermined position on the top surface of each valve lifter 8 according to a swinging position of the swingable cam 9.

The transmission mechanism includes a rocker arm 11, a link arm 12, and a link rod 13. The rocker arm 11 is disposed above the driving shaft 6. The link arm 12 connects one end portion 11a of the rocker arm 11 and the driving cam 7 to each other. The link rod 13 connects an opposite end portion 11b of the rocker arm 11 and the swinging cam 9 to each other. The rocker arm 11 is arranged in such a manner that a cylindrical base portion provided at a center thereof is rotationally supported on a control cam, which will be described below, via a support hole, and the one end portion 11a thereof is also rotatably coupled with the link arm 12 by a pin 14 while the opposite end portion lib thereof is rotatably coupled with one end portion of the link rod 13 via a pin 15.

The link arm 12 includes a fitting hole formed at a central portion of a relatively large-diameter annular base portion 12a, to which the cam main body of the driving cam 7 is rotatably fitted, while a protrusion end 12b is coupled with the rocker arm one end portion 11a by the pin 14. An opposite end portion of the link rod 13 is rotatably coupled with the cam nose portion of the swingable cam 9 via a pin 16. Further, a control shaft 17 is rotatably supported by the same bearing member at a position above the driving shaft 6, and a control cam 18 is also fixed on an outer periphery of the control shaft 17 while being swingably fitted in the support hole of the rocker arm 11. The control cam 18 serves as a support point of a swinging movement of the rocker arm 11.

The control shaft 17 is arranged in parallel with the driving shaft 6 in a longitudinal direction of the engine, and is also rotationally controlled by a driving mechanism 19. On the other hand, the control cam 18 is cylindrical, and a central axis position thereof is eccentric from the central axis of the control shaft 17 by a predetermined amount. The driving mechanism 19 includes an electric motor 20 and a transmission unit 21. The electric motor 20 is fixed to one end portion of a not-illustrated housing. The transmission unit 21 is provided inside the housing and transmits a rotational driving force of the electric motor 20 to the control shaft 17. The electric motor 20 includes a proportional DC motor, and is configured to be driven by a control signal from the controller 22, which serves as an engine control unit that detects an engine operational state.

The transmission unit 21 mainly includes a ball screw shaft 23, a ball nut 24, a linkage arm 25, and a link member 26. The ball screw shaft 23 is disposed approximately coaxially with the driving shaft of the electric motor 20. The ball nut 24 is a movable member threadably engaged with an outer periphery of the ball screw shaft 23. The linkage arm 25 is coupled with one end portion of the control shaft 17 along a diametral direction. The link member 26 links the linkage arm 25 and the ball nut 24 with each other. The ball screw shaft 23 is configured in such a manner that a ball circulation groove having a predetermined width is spirally continuously formed over an entire outer peripheral surface except for both end portions, and is also configured in such a manner that a rotational driving force of the driving shaft of the electric motor 20 coupled to one end portion thereof is transmitted thereto.

The ball nut 24 is configured in such a manner that a guide groove is spirally continuously formed on an inner peripheral surface for rollably holding a plurality of balls in cooperation with the ball circulation groove, and an axial movement force is applied thereto while a rotational movement of the ball screw shaft 23 is converted into a linear movement of the ball nut 24 via each of the balls. Further, the ball nut 24 includes a driving shaft angle sensor 28 and a rotational angle sensor 29. The driving shaft angle sensor 28 detects a rotational angle of the driving shaft 6. The rotational angle sensor 29 detects a rotational angle of the control shaft 17.

Next, as illustrated in FIG. 2, the second variable actuation valve mechanism 2 includes the sprocket 30 and a phase control hydraulic actuator 32. The sprocket 30 is provided at a front end portion of the driving shaft 6. The phase control actuator 32 rotates these sprocket 30 and driving shaft 6 relative to each other within a predetermined angular range. The sprocket 30 moves in conjunction with the crankshaft via the not-illustrated timing chain or timing belt.

Supply of a hydraulic pressure to the phase control hydraulic actuator 32 is controlled by a not-illustrated second hydraulic control portion based on a control signal from the same controller 22. Due to this hydraulic control to the phase control hydraulic actuator 32, the sprocket 30 and the driving shaft 6 rotate relative to each other and a central phase θ of a lift characteristic is retarded or advanced. In other words, the entire lift characteristic is advanced or retarded without a curve of the lift characteristic itself changed. Further, this change can also be acquired continuously. The second variable actuation valve mechanism 2 can be configured in various manners, such as using an electric motor or an electromagnetic actuator without being limited to using the hydraulic actuator. These configurations are also well known, and will not be elaborated more than that herein.

Further, as illustrated in FIGS. 1 and 2, the controller (=a control unit) 22 detects a current engine state based on various kinds of information signals, such as an output signal from a crank angle sensor, which detects the current number of rotations N (rpm) of the internal combustion engine from a crank angle, an intake air amount (a load) from an air flow meter, and, besides them, an accelerator position sensor, a vehicle speed sensor, a gear position sensor, an engine cooling water temperature sensor 31, which detects a temperature of the main body of the engine, and, further, a humidity in an intake pipe from an atmospheric humidity sensor.

Further, the controller 22 is configured to input detection signals from the driving shaft angle sensor 28, which detects the rotational angle of the driving shaft 6, and the rotational angle sensor 29 of the control shaft 17, and is configured to detect a relative rotational position between the sprocket 30 and the driving shaft 6, which will be described below, i.e., a position of the phase variable mechanism 2 based on the signals from the crank angle sensor and the driving shaft angle sensor 28. Further, the controller 22 is configured to detect a position of the first variable actuation valve mechanism 1 based on an information signal from the rotational angle sensor 29 of the control shaft 17.

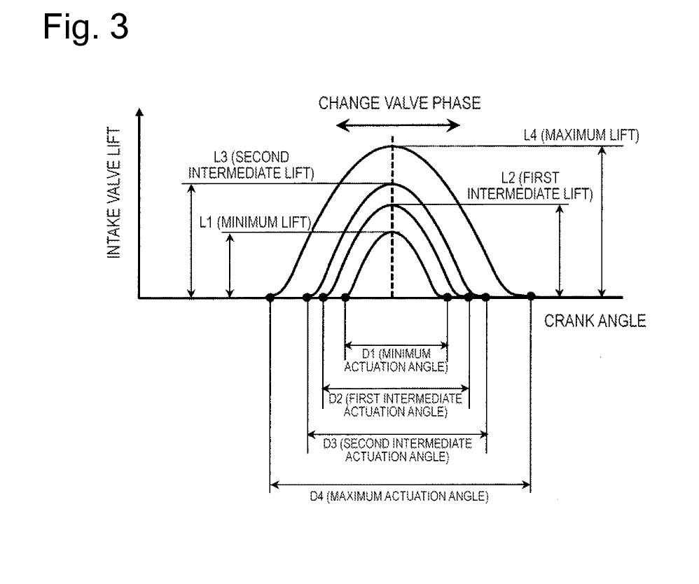

FIG. 3 illustrates a state of a change in the lift/actuation angle of each of the first variable actuation valve mechanism 1 and the second variable actuation valve mechanism 2. According to the first variable actuation valve mechanism 1, the intake valve lift can change from a minimum lift L1 to a first intermediate lift L2, a second intermediate lift L3, and a maximum lift L4, and the actuation angle, which corresponds to the valve opening period, can change from a minimum actuation angle D1 to a first intermediate actuation angle D2, a second intermediate actuation angle D3, and a maximum actuation angle D4 in correspondence therewith.

Further, separately therefrom, the second variable actuation valve mechanism 2 is configured to be able to adjust the central phase angle θ by shifting the lift characteristic toward an advance-angle side or a retard-angle side as a whole without changing the actuation angle while keeping each of the lift characteristics (L1 to L4).

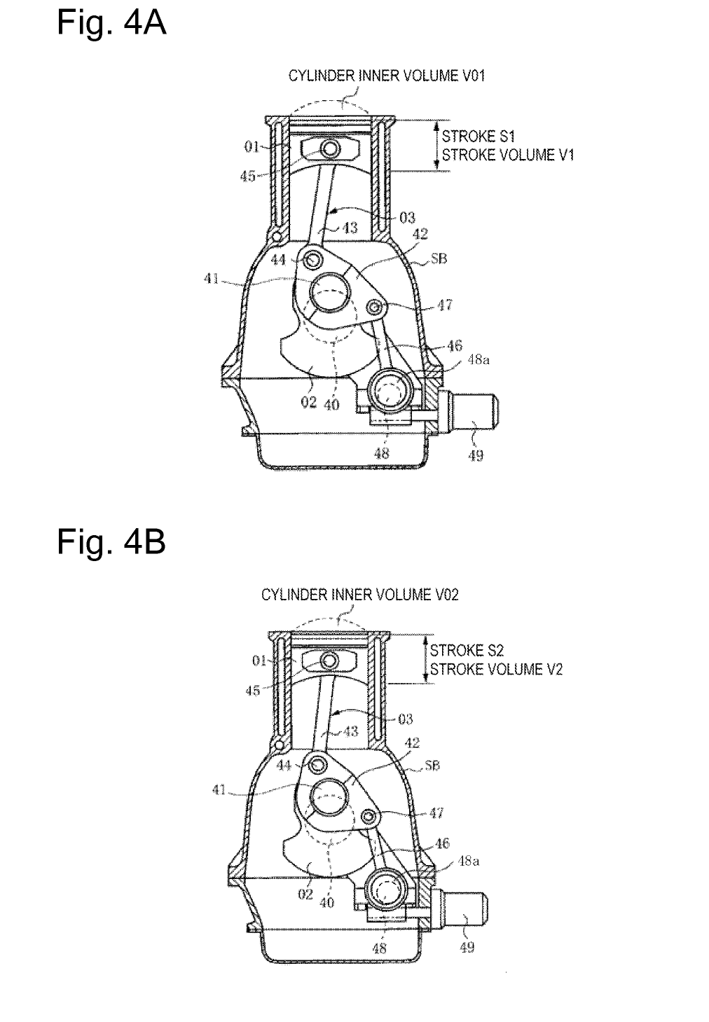

Next, the variable compression ratio mechanism 3 will be described with reference to FIG. 1 and FIGS. 4A and 4B. FIG. 4A illustrates a piston position at a compression top dead center at a minimum mechanical compression ratio, and FIG. 4B illustrates a piston position at a compression top dead center at a maximum mechanical compression ratio. Further, focusing on positions at an exhaust top dead center, the piston positions at the exhaust top dead center also coincide with the piston positions at the compression top dead center illustrated in FIGS. 4A and 4B both at the maximum mechanism compression ratio and the minimum mechanical compression ratio.

This variable compression ratio mechanism 3 is a mechanism that completes one cycle based on a crank angle of 360 degrees, and therefore is configured in such a manner that the piston position at the compression top dead center and the piston position at the exhaust top dead center coincide with each other in principle. Further, for the same reason, a piston position at an intake bottom dead center and a piston position at an expansion bottom dead center also coincide with each other. This means that a compression stroke from the piston position at the intake bottom dead center to the piston position at the compression top dead center, and an expansion stroke from the piston position at the compression top dead center to the piston position at the expansion bottom dead center also match each other any time. Therefore, the mechanical compression ratio εC and the mechanical expansion ratio εE also match each other in principle.

The variable compression ratio mechanism 3 is configured similarly to the configuration disclosed in the above-described patent literature, PTL 1. The structure thereof will be briefly described. The crankshaft 02 includes a plurality of journal portions 40 and a crank pin portion 41, and the journal portions 40 are rotatably supported on a main bearing of the cylinder block SB. The crank pin portion 41 is eccentric from the journal portions 40 by a predetermined amount, and a lower link 42, which serves as a second link, is rotatably coupled therewith. The lower link 42 is configured to be dividable into left and right two members, and the above-described crank pin portion 41 is fitted in a coupling hole located approximately at a center.

An upper link 43, which serves as a first link, has a bottom end side rotatably coupled with one end of the lower link 42 by a coupling pin 44 and a top end side rotatably coupled with the piston 01 by a piston pin 45. A control link 46, which serves as a third link, has a top end side rotatably coupled with an opposite end of the lower link 42 by a coupling pin 47 and a bottom end side rotatably coupled with a lower portion of the cylinder block SB, which is a part of the engine main body, via a control shaft 48.

The control shaft 48 is rotatably supported on the engine main body, and also includes an eccentric cam portion 48a eccentric from a rotational center thereof. The bottom end portion of the control link 46 is rotatably fitted to this eccentric cam portion 48a. A rotational position of the control shaft 48 is controlled by a compression ratio control actuator 49 using an electric motor based on a control signal from the controller 22.

In the variable compression ratio mechanism 3 using such a multi-link piston-crank mechanism, a central position of the eccentric cam portion 48a, especially, a relative position thereof relative to the engine main body is changed when the control shaft 48 is rotated by the compression ratio control actuator 49. This results in a change in a swinging movement support position at the bottom end of the control link 46. Then, the change in the swinging movement support position of the control link 46 causes a change in a stroke of the piston 01, thereby raising or lowering a position of the piston 01 at a piston top dead center as illustrated in FIGS. 4A and 4B. This allows the mechanical compression ratio EC to be changed.

This mechanical compression ratio εC is a geometric compression ratio determined only based on a change in a volume of a combustion chamber due to the stroke of the piston 01, and is a ratio between a cylinder inner volume at the bottom dead center during an intake stroke of the piston 01 and a cylinder inner volume at the top dead center during a compression stroke of the piston 01. FIG. 4A illustrates the state at the minimum mechanical compression ratio and FIG. 4B illustrates the state at the maximum mechanical compression ratio, and the compression ratio can be continuously changed between them.

Now, assuming that VO and V represent the cylinder inner volume and a stroke volume at the compression top dead center of the piston, the cylinder inner volume at the bottom dead center of the piston is expressed as (VO+V) and therefore the mechanical compression ratio εC can be expressed as εC=(VO+V)/VO=V/VO+1. From this point of view, the minimum mechanical compression ratio MinεC (=the minimum mechanical expansion ratio MinεE) illustrated in FIG. 4A is expressed as MinεC=V1/VO1+1 (for example, MinεC=9), and the maximum mechanical compression ratio MaxεC (=the maximum mechanical expansion ratio MaxεE) illustrated in FIG. 4B is expressed as MaxεC=V2/VO2+1 (for example, MaxεC=15).

Then, as discussed in the above-described paragraph “Technical Problem”, the control of reducing the mechanical compression ratio εC as the engine torque increases is proposed for the internal combustion engine including the variable compression ratio mechanism 3. This is because the aim thereof is to achieve the increase in the maximum engine torque by advancing the ignition timing after improving the knocking resistance capability by reducing the mechanical compression ratio εC. This control can improve the knocking resistance capability without increasing the fuel (increasing the latent heat of the vaporization), thereby being expected to bring about the effect of improving the fuel economy.

However, this method also leads to the reduction in the mechanical expansion ratio εE along with the reduction in the mechanical compression ratio εC, thereby newly raising the problem of facilitating the occurrence of thermal damage on the exhaust-system component around the maximum engine torque (load) because the temperature of the exhaust gas also increases, as well as the thermal efficiency reduces and thus the fuel economy is deteriorated.

To solve such a problem, the present embodiment proposes a control method that will be described below. The following description will focus on, in the internal combustion engine including the first variable actuation valve mechanism 1, the second variable actuation valve mechanism 2, and the variable compression ratio mechanism 3 configured in this manner, control operations of the first variable actuation valve mechanism 1, the second variable actuation valve mechanism 2, and the variable compression ratio mechanism 3 when an operation region (an engine torque) is changed.

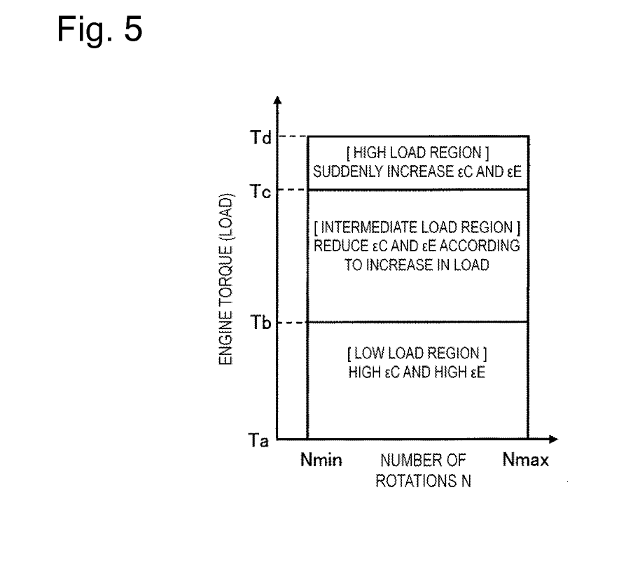

FIG. 5 illustrates categorization of the operation region according to the engine torque and the number of rotations N, and the operation region is categorized into a low load region (Ta to Tb) of a low engine torque, an intermediate load region (Tb to Tc) of an intermediate engine torque, and a high load region (Tc to Td) of a high engine torque. The operation region is categorized into the three regions in this categorization for convenience, but the operation region can also be categorized into regions more than that, and the number of rotations N can also be set for each of the plurality of regions.

Now, because the engine torque correlates with an amount of pressing the accelerator pedal, the variable system is configured to estimate the engine torque from the amount of pressing the accelerator pedal in the present embodiment. Further, the number of rotations N is set so as to change from Nmin, assuming an idle rotation state or the like, to Nmax, assuming a maximum output state or the like. Therefore, which region the current operation state belongs to can be determined based on the detected number of rotations N and the amount of pressing the accelerator pedal (the engine torque).

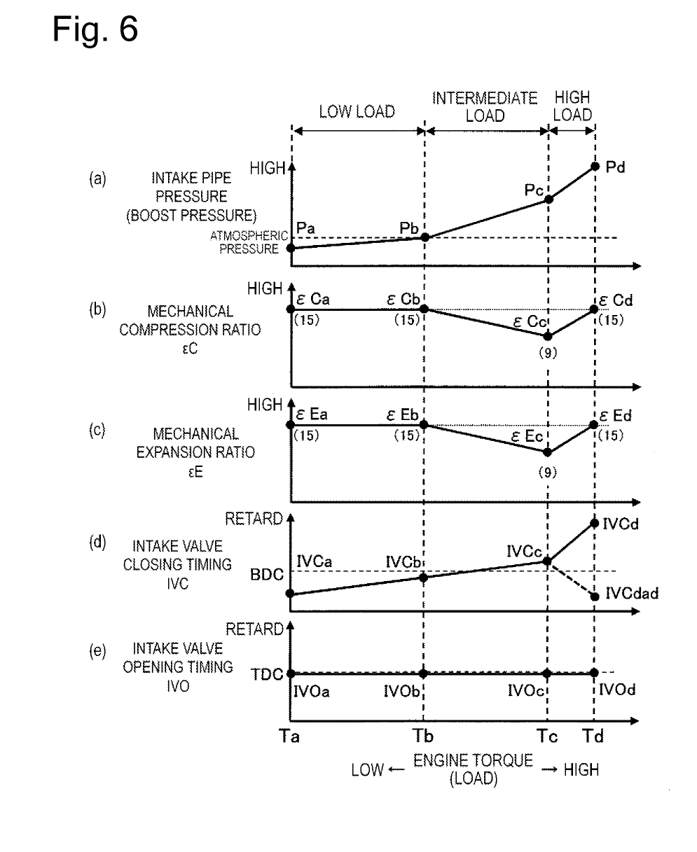

As illustrated in FIG. 5, the mechanical compression ratio εC and the mechanical expansion ratio εE are set to high values in the low load region (Ta to Tb), set to values reducing according to an increase in the load in the intermediate load region (Tb to Tc), and set to suddenly increasing values in the high load region (Tc to Td). These settings are illustrated in FIGS. 6(b) and 6(c) in detail, and therefore will be described in detail with reference to FIGS. 6(a) to 6(e).

FIG. 5 illustrates a boundary portion between the low load region and the intermediate load region and a boundary region between the intermediate load region and the high load region as if boundary torque values (Tb and Tc) do not change according to the number of rotations N, but they may also be set to different torques according to the number of rotations N. Further, FIG. 5 also illustrates a maximum torque value (Td) set to guarantee durability of a driving system and the like as if it does not change according to the number of rotations N, but it may also be set to a different torque value according to the number of rotations N.

Then, FIGS. 6(a) to 6(e) each illustrate a control characteristic of a control parameter for each engine torque region controlled by the present embodiment. In the present embodiment, the variable system is configured to control the first variable actuation valve mechanism 1, the second variable actuation valve mechanism 2, and the variable compression ratio mechanism 3 so as to be able to acquire this control characteristic of the control parameter. Now, FIGS. 6(a) to 6(e) illustrate the change in the boost pressure, the change in the mechanical compression ratio εC, the change in the mechanical expansion ratio εE, the change in the closing timing of the intake valve, and the change in the opening timing of the intake valve in correspondence with the strength of the engine torque (Ta to Td), respectively.

Now, in the present embodiment, the variable system employs a control characteristic in which the mechanical compression ratio εC and the mechanical expansion ratio εE are set to “15” and “15”, respectively, in the low load region, employs a control characteristic in which the mechanical compression ratio εC and the mechanical expansion ratio εE reduce like from “15” to “9” and “15” to “9”, respectively, according to the increase in the engine torque in the intermediate load region, and employs a control characteristic in which the mechanical compression ratio εC and the mechanical expansion ratio εE increase like from “9” to “15” and “9” to “15”, respectively, according to the increase in the engine torque in the high load region. In the following description, the control characteristic for each of the load regions will be described.

<<Low Load Region Ta to Tb>> First, the boost pressure is kept from Pa to Pb in the low load region (Ta to Tb) in which the accelerator position (=the amount of pressing the accelerator pedal) is low. Then, the variable compression ratio mechanism 3 is controlled in such a manner that the mechanical compression ratio matches the maximum mechanical compression ratio MaxεE illustrated in FIG. 6(b) and the mechanical expansion ratio matches the maximum mechanical expansion ratio MaxεE illustrated in FIG. 6(c). As illustrated in FIGS. 6(a) to 6(e), the values of these maximum mechanical compression ratio MaxεC and maximum mechanical expansion ratio MaxεE are controlled to predetermined mechanical compression ratio εC and mechanical expansion ratio εE of, for example, approximately “15”.

Further, in the low load region (Ta to Tb), the closing timing IVC of the intake valve is controlled to an early timing before the intake bottom dead center BDC like IVCa to IVCb as illustrated in FIG. 6(d). Further, the opening timing IVO of the intake valve is controlled to approximately the top dead center TDC like IVOa to IVOb as illustrated in FIG. 6(e).

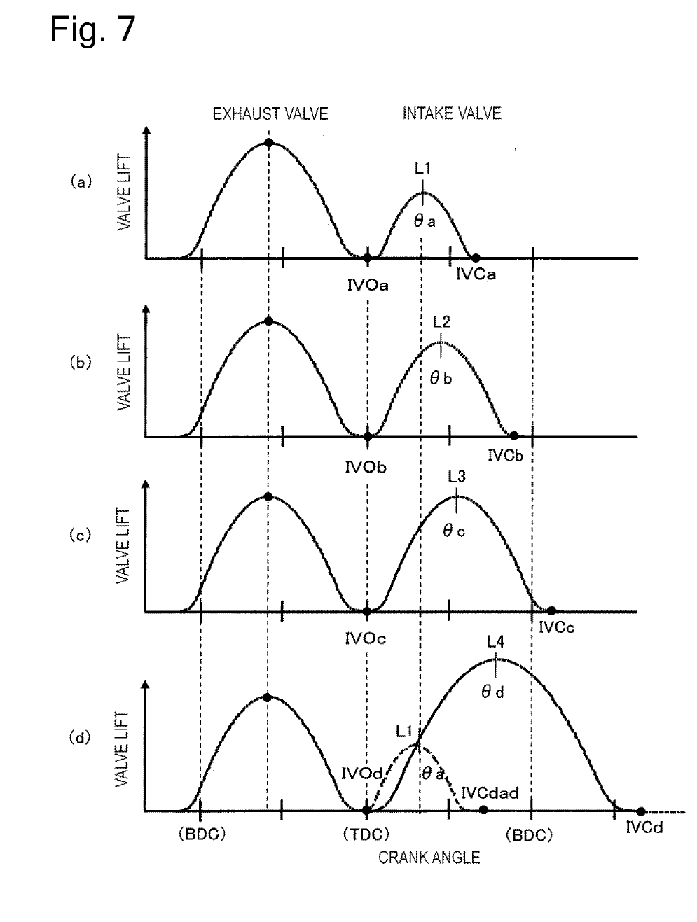

Such a valve timing can be realized by a combination of the first variable actuation valve mechanism 1 and the second variable actuation valve mechanism 2 as illustrated in FIG. 7(a). More specifically, when the engine torque is the engine torque Ta, the opening timing IVO of the intake valve is placed at the opening timing IVOa around the top dead center TDC and the closing timing IVC of the intake valve is placed at the closing timing IVCa sufficiently advanced from the intake bottom dead center BDC by setting the minimum lift L1/actuation angle D1 by the first variable actuation valve mechanism 1 and controlling the central phase angle θ to a maximumly advanced angle θa by the second variable actuation valve mechanism 2.

An effect of reducing a pump loss to improve the fuel economy can be acquired by closing the intake valve early like the closing timing IVCa to thus largely open the throttle valve and set the low engine torque Ta in this manner.

Next, when the accelerator pedal is pressed and the engine torque increases to the engine torque Tb, the lift is set to the first intermediate lift L2/actuation angle D2 slightly larger than the minimum lift L1 by the first variable actuation valve mechanism 1, and, further, the central phase angle θ is controlled to a central phase angle θb slightly retarded from the maximum advance angle θa by the second variable actuation valve mechanism 2, as illustrated in FIG. 7(b). As a result, the opening timing IVO of the intake valve is placed at an opening timing IVOb (≈IVOa) around the top dead center TDC, and the closing timing IVC is placed at a closing timing IVCb slightly advanced from the intake bottom dead center BDC. The pump loss can be reduced and the fuel economy can be improved similarly to when the engine torque is the low engine torque Ta, by closing the intake valve early like the closing timing IVCb to thus largely open the throttle valve and set the low engine torque Tb in this manner.

Then, in the low load region (Ta to Tb), the opening timing IVO of the intake valve little changes as indicated by IVOa and IVOb, so that an internal EGR amount introduced during an overlap period is stabilized, which prevents the internal EGR amount from changing even with a transient change occurring during the low load region (Ta to Tb), thereby allowing the internal combustion engine to realize stable combustion.

Further importantly, during the low load region (Ta to Tb), the mechanical compression ratio εC is controlled to the large value “15”, which can cancel out a reduction in the temperature at the compression top dead center (an effective compression ratio) due to the advanced closing timing IVC of the intake valve so as to close the intake valve early, thereby allowing the internal combustion engine to realize further excellent combustion. In addition, the mechanical expansion ratio εE is also controlled to the large value “15”, which increases expansion work and also improves theoretical thermal efficiency, thereby allowing the internal combustion engine to significantly improve the fuel economy in the low load region (Ta to Tb).

<<Intermediate Load Region Tb to Tc>> Next, in the intermediate load region in which the accelerator pedal is further pressed (Tb to Tc), as the closing timing IVC of the intake valve is being shifted from the closing timing IVCb to the intake bottom dead center BDC, charging efficiency is being enhanced and the engine torque is further increasing after exceeding the engine torque Tb. Then, the opening timing IVO of the intake valve is set to the opening timing IVO around the top dead center TDC and therefore is kept approximately constant like the opening timing IVOb to the opening timing IVOc, which prevents or reduces the change in the internal EGR amount and ensures stability of the combustion.

Next, when the accelerator pedal is pressed and the engine torque increases to the engine torque Tc, the lift is set to the second intermediate lift L3/actuation angle D3 larger than the first intermediate lift L2 by the first variable actuation valve mechanism 1, and, further, the central phase angle θ is controlled to a central phase angle θc slightly retarded from the central phase angle θb by the second variable actuation valve mechanism 2, as illustrated in FIG. 7(c). As a result, the opening timing IVO of the intake valve is placed at the opening timing IVOc (≈IVOa, IVOb) around the top dead center TDC, and the closing timing IVC is placed at the closing timing IVCc slightly retarded from the intake bottom dead center BDC.

Then, the increase in the engine torque causes an increase in the exhaust gas amount and thus an increase in the number of rotations of the turbine 73 of the turbocharger 70, thereby causing an intake pipe pressure due to the compressor 71 (the boost pressure) to start rising. At this time, keeping the mechanical compression ratio εC at a high ratio raises a concern about the occurrence of the knocking, and therefore the mechanical compression ratio εC is controlled so as to gradually reduce from “15” to “9” in the intermediate load region (Tb to Tc) as illustrated in FIG. 6(b). Further, along therewith, the mechanical expansion ratio εE is also being changed so as to gradually reduce from “15” to “9” according to the reduction in the mechanical compression ratio EC in the intermediate load region (Tb to Tc) as illustrated in FIG. 6(c).

Then, the closing timing IVC of the intake valve is being gradually retarded according to the increase in the engine torque as indicated in the intermediate load region (Tb to Tc) illustrated in FIG. 6(d). When the closing timing IVC reaches the closing timing IVCc slightly exceeding the intake bottom dead center BDC, the charging efficiency significantly increases and the boost pressure also increases. The knocking easily occurs in this state, and therefore the variable system operates so as to prevent the knocking by considerably reducing the mechanical compression ratio εC (=mechanical expansion ratio εE) to around “9” at this time.

<<High Load Region Tc to Td>> Next, in the high load region (Tc to Td) in which the accelerator pedal is further pressed, when the throttle valve is fully opened from a high opening degree (for example, approximately an 80% opening degree), the charging efficiency further increases and the exhaust gas amount also increases. Therefore, the rotation of the compressor 71 of the turbocharger 70 increases, and the boost pressure increases to reach the maximum engine torque Td set to guarantee the durability of the driving system, and furthermore, may even undesirably exceed this maximum engine torque Td.

In this case, normally-practiced common control largely opens the waste gate valve 77 to cause a considerable amount of the exhaust gas to bypass so as to prevent it from flowing to the turbocharger, thereby preventing or cutting down an increase in the boost pressure due to the turbocharger 70. This method allows the variable system to control the engine torque so as not to exceed the maximum engine torque Td, but may raise a problem of facilitating the occurrence of the thermal damage on the exhaust-system component around the maximum engine torque Td due to the increase in the temperature of the exhaust gas as well as the thermal efficiency reduces and thus the fuel economy is deteriorated, because the mechanical expansion ratio εE significantly reduces in this case. Then, keeping the waste gate valve 77 opened means that the high-temperature exhaust gas directly acts on the exhaust-system component without passing through the turbocharger 70 holding a thermal capacity and having a cooling effect, and leads to a possibility that this method results in further noticeable thermal damage.

Being around the engine maximum torque in this case refers to, for example, when the opening degree of the throttle valve is 80% or higher.

Now, another conceivable method is to increase a concentration of an air-fuel mixture to reduce the temperature of the exhaust gas (fuel cooling), but this case also raises a problem of further deteriorating the fuel economy. Alternatively, further another conceivable method is to retard an ignition timing to allow the engine torque to fall within the maximum engine torque Td, but this method raises a problem of further deteriorating the thermal damage, because the combustion phase is delayed in this case, and therefore the temperature of the exhaust gas further increases and the high-temperature exhaust gas flows to the exhaust-system component.

On the other hand, in the present embodiment, the variable system performs control so as to suddenly considerably retard the closing timing IVC of the intake valve to the closing timing IVCd to reduce intake charging efficiency and also increase the mechanical compression ratio εC (=the mechanical expansion ratio εE) to, for example, “15” as illustrated in FIG. 6(d) without opening the waste gate valve 73 (or without including the waste gate valve 73 when the engine torque reaches the maximum engine torque Td set to guarantee the durability of the driving system.

More specifically, when the accelerator pedal is pressed to open the throttle valve to around a fully opened state and the engine torque increases to the engine torque Td, the variable system sets the lift to the maximum lift L4/actuation angle D4 larger than the second intermediate lift L3 by the first variable actuation valve mechanism 1, and, further, controls the central phase angle θ to a central phase angle θd largely retarded from the central phase angle θc by the second variable actuation valve mechanism 2, as illustrated in FIG. 7(d). Due to this control, the variable system can reduce the intake charging efficiency, with the opening timing IVO of the intake valve placed at the opening timing IVOd (≈IVOa, IVOb, and IVOc) around the top dead center TDC, and the closing timing IVC placed at the closing timing IVCd largely retarded from the intake bottom dead center BDC.

As a result, the variable system can reduce the engine torque to around the maximum engine torque Td even without opening the waste gate valve 73. Further, the variable system becomes able to reduce the effective compression ratio (the actual compression ratio) to enhance the knocking resistance capability by placing the closing timing IVC of the intake valve at the closing timing IVCd largely retarded from the intake bottom dead center BDC. Further, the variable system can improve the thermal efficiency (=the fuel economy) by setting the large mechanical expansion ratio εEd (=15), which further allows the variable system to reduce the temperature of the exhaust gas. This effect allows the variable system to acquire excellent fuel economy while preventing or reducing the thermal damage on the exhaust-system component around the maximum engine torque Td.

Therefore, the variable system neither leads to the increase in the temperature of the exhaust gas and the deterioration of the fuel economy due to the ignition timing excessively retarded to reduce the engine torque or enhance the knocking resistance capability, nor leads to the deterioration of the fuel economy due to the air-fuel mixture containing rich fuel to reduce the temperature of the exhaust gas. Further, the variable system can achieve the increase in the torque (the increase in the combustion work) due to the high mechanical expansion ratio εEd in addition to the increase in the torque due to the improvement of the knocking resistance capability although the charging efficiency reduces, by placing the closing timing IVC of the intake valve at the closing timing IVCd largely retarded from the intake bottom dead center BDC. Therefore, the variable system can also acquire a synergy effect of preventing or cutting down the reduction in the maximum torque value (for example, an unintended reduction in the torque) and securing the target maximum engine torque Td.

In this manner, in the present embodiment, the opening timing IVO of the intake valve is set to approximately the constant timing around the top dead center TDC according to the increase in the engine torque. On the other hand, the closing timing IVC of the intake valve is set so as to have a characteristic of being gradually retarded from the phase angle advanced from the intake bottom dead center BDC to the phase angle retarded from the intake bottom dead center BDC as far as a predetermined first region (the low load region) and a predetermined second region (the intermediate load region), and being retarded to the phase angle further largely retarded from the intake bottom dead center BDC compared to the second region in a predetermined third region (the high load region).

At this time, the characteristic of the mechanical compression ratio εC (=the mechanical expansion ratio εE) is set in such a manner that this ratio is set to the approximately constant high value in the first region, is controlled so as to gradually reduce according to the increase in the engine torque in the second region, and is controlled so as to suddenly largely increase according to the increase in the engine torque in the third region. Controlling the mechanical compression ratio εC in this manner allows the variable system to reduce the effective compression ratio to enhance the knocking resistance capability by retarding the closing timing of the intake valve from the intake bottom dead center BDC, and, further, to achieve the improvement of the thermal efficiency (=the improvement of the fuel economy) and also reduce the temperature of the exhaust gas to prevent or reduce the thermal damage on the exhaust-system component by increasing the mechanical expansion ratio εE, around the maximum engine torque.

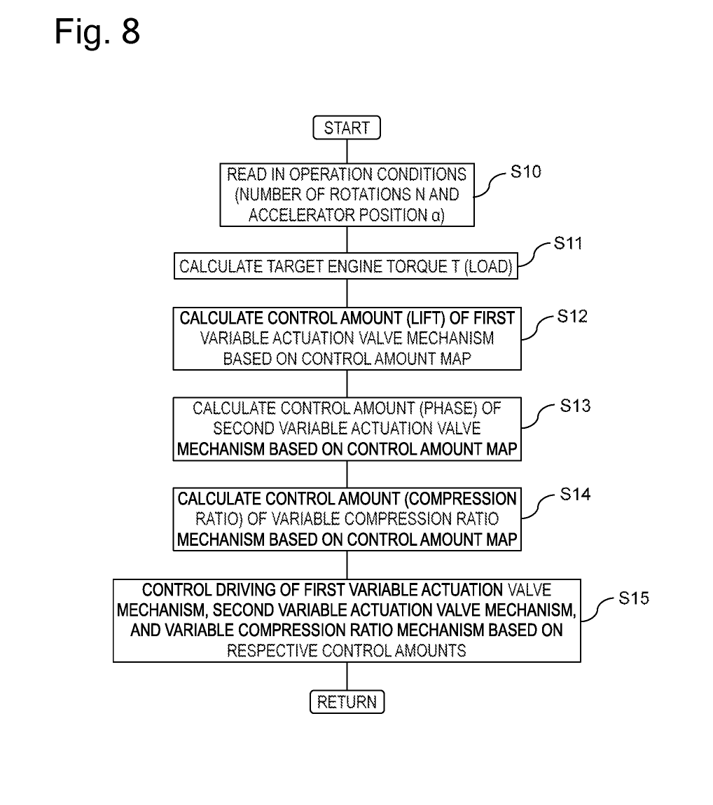

Next, a flow for controlling the first variable actuation valve mechanism 1, the second variable actuation valve mechanism 2, and the variable compression ratio mechanism 3 according to the present embodiment will be briefly described with reference to FIG. 8. The control flow illustrated in FIG. 8 is a control flow started up at a startup timing that comes every predetermined time, and started up according to a re-arrival of the next startup timing once all of predetermined control steps are performed.

Referring to FIG. 8, in step S10, the variable system reads in the number of rotations N of the internal combustion engine and the accelerator position α to estimate the target engine torque. The engine torque can be estimated with use of another operation information different from these pieces of operation information, and may be estimated with use of any operation information appropriately as necessary. After the variable system completing reading in the number of rotations N and the accelerator position α, the processing proceeds to step S11.

In step S11, the variable system calculates the target torque T with use of a predetermined calculation equation or map based on the read number of rotations N and accelerator position α. This target torque T is used to determine the operation region illustrated in FIG. 5, and, furthermore, is used to calculate control amounts of the first variable actuation valve mechanism 1, the second variable actuation valve mechanism 2, and the variable compression ratio mechanism 3 in correspondence with the engine torque illustrated in FIGS. 6(a) to 6(e). After the target torque T is calculated, the processing proceeds to step S12.

In step S12, the variable system calculates the control amount of the first variable actuation valve mechanism 1 according to the characteristic illustrated in FIGS. 6(a) to 6(e). In this case, basically, the variable system determines the lift characteristic of the intake valve. As illustrated in FIGS. 7(a) to 7(d), the valve lift is determined according to the strength of the engine torque. These control characteristics are stored in a map in which the engine torque is used as a parameter, and an appropriate value is set by match finding work (matching). Further, the control characteristics of the second variable actuation valve mechanism 2 and the variable compression ratio mechanism 3, which will be described below, are also stored in a map by a similar method. After the valve lift is determined, the processing proceeds to step S13.

In step S13, the variable system calculates the control amount of the second variable actuation valve mechanism 2 according to the characteristic illustrated in FIGS. 6(a) to 6(e). In this case, basically, the variable system determines the central phase angle of the intake valve. As illustrated in FIGS. 7(a) to 7(d), the central phase angle is determined based on the strength of the engine torque. In this case, the central phase angle is determined so as to acquire the opening timing IVO and the closing timing IVC of the intake valve illustrated in FIGS. 7(a) to (d) in cooperation with the first variable actuation valve mechanism 1. After the central phase angle is determined, the processing proceeds to step S14.

In step S14, the variable system calculates the control amount of the variable compression ratio mechanism 3 according to the characteristic illustrated in FIGS. 6(a) to 6(e). In this case, basically, the piston stroke characteristic is determined as illustrated in FIGS. 4A and 4B. After the piston stroke characteristic is determined, the processing proceeds to step S15.

In step S15, the variable system controls driving of the first variable actuation valve mechanism 1, the second variable actuation valve mechanism 2, and the variable compression ratio mechanism 3 so as to achieve the control characteristic illustrated in FIGS. 6(a) to 6(e) and FIGS. 7(a) to (d) based on the control amounts of the first variable actuation valve mechanism 1, the second variable actuation valve mechanism 2, and the variable compression ratio mechanism 3 acquired in steps S12, S13, and S14. After this driving control is ended, the processing proceeds to RETURN, and the various system is brought into a waiting state until the startup timing comes again.

In FIG. 5 and FIGS. 6(a) to 6(e), the variable system can also set the engine torque Tc and the engine torque Td to approximately the same values, i.e., cause the mechanical expansion ratio εE to transition from the mechanical expansion ratio εEc to the mechanical expansion ratio εEd with a slight time lag therebetween without especially providing the high load region, and also shift the closing timing IVC from the closing timing IVCc to the closing timing IVCd in a similar manner.

### Second Embodiment

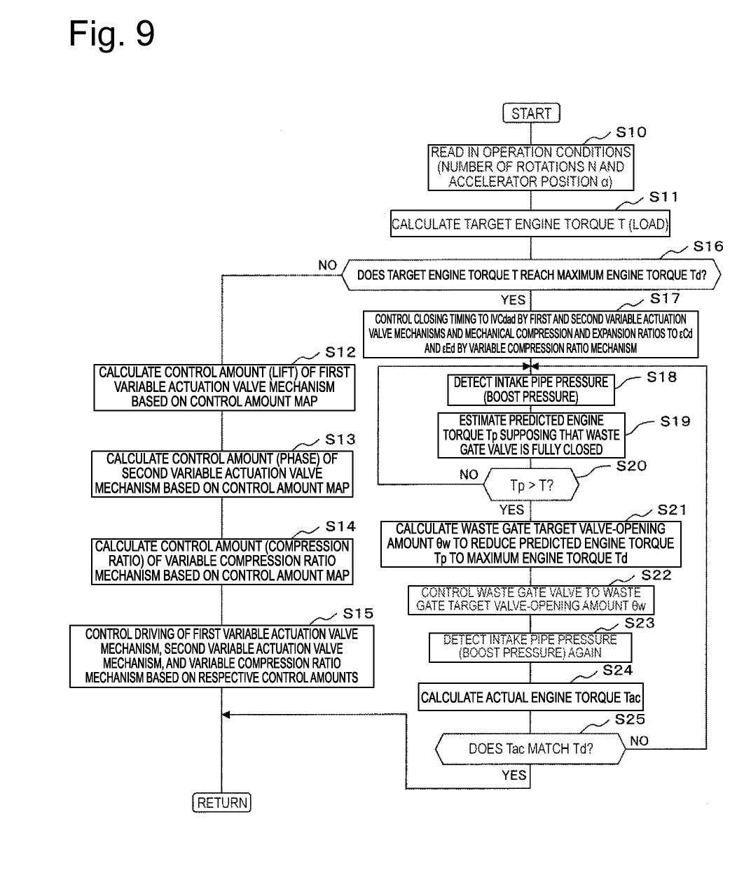

Next, a second embodiment of the present invention will be described with reference to FIG. 9. The above-described embodiment proposes the method that controls the waste gate valve 73 to close it when the engine torque reaches the maximum engine torque Td set to guarantee the durability of the driving system. The present embodiment is different therefrom in terms of controlling the waste gate valve 77 to open it around the maximum engine torque Td. Further, the present embodiment is different from the first embodiment in terms of closing the intake valve at the closing timing IVC that is not the closing timing IVCd on the retard-angle side but is a closing timing IVCdad on the advance-angle side at the maximum engine torque Td. The closing timing IVCdad has approximately the same characteristic as the closing timing IVCa in the low load region.

Now, the closing timing IVC of the intake valve at the maximum engine torque Td is set to the retard-angle side as seen in the first embodiment in some cases and is set to the advance-angle side as seen in the second embodiment in other cases based on the intake bottom dead center BDC. Therefore, in the present invention, the closing timing IVCd set on the retard-angle side and the closing timing IVCdad set on the advance-angle side can be collectively restated as a “closing timing IVC spaced apart from the intake bottom dead center BDC”, which is a broader concept.

Next, a detailed control flow according to the present embodiment will be described with reference to FIG. 9. The same reference numerals as FIG. 8 indicate the same control steps, and therefore descriptions thereof will be omitted below.

After completing the processing in steps S10 and S11, in step S16, the variable system determines whether the targeted engine torque T acquired in step S11 reaches the maximum engine torque Td. If the engine torque T does not reach the maximum engine torque calculation Td, the processing proceeds to step S12, in which the variable system performs the control illustrated in FIG. 8, but the control at this time has been described in the description of FIG. 8 and therefore will not be repeated here. On the other hand, if the engine torque T is determined to reach the maximum engine torque calculation Td, the processing proceeds to step S17.

In step S17, the variable system controls the lift to the lift characteristic L1 indicated by broken lines in FIGS. 6(d) and 7(d) by the first variable actuation valve mechanism 1 and the second valve actuation valve mechanism 2. In other words, the closing timing IVC of the intake valve is controlled to an early timing prior to the intake bottom dead center BDC like the closing timing IVCdad. Further, the opening timing IVO of the intake valve is controlled to around approximately the top dead center TDC like IVOd as illustrated in FIGS. 6(e) and 7(d). The variable compression ratio mechanism 3 will not be described here because having a control characteristic defined as described above.

In this manner, setting the valve lift to the low lift characteristic L1 contributes to a reduction in an absolute amount of the exhaust gas amount (corresponding to an intake air amount) and thus a reduction in an absolute amount of exhaust gas released via the waste gate valve 77, thereby succeeding in further preventing or reducing the thermal damage on the exhaust-system component caused by a wake with the aid of the synergy effect thereof with the effect of reducing the temperature of the exhaust gas due to the high mechanical expansion ratio εE. After the end of the driving control on the first variable actuation valve mechanism 1, the second variable actuation valve mechanism 2, and the variable compression ratio mechanism 3, the processing proceeds to step S18.

In step S18, the variable system detects the boost pressure (the pressure in the intake pipe) due to the supercharging function of the turbocharger 70. After this boost pressure is detected, the processing proceeds to step S19.

In step S19, the variable system estimates a predicted engine torque Tp predictable when hypothetically supposing that the waste gate valve 77 is fully closed. The target engine torque T has been determined to reach the maximum engine toque Td in step S16. Then, the variable system detects the pressure in the intake pipe (the boost pressure), and estimates and calculates the predicted engine torque Tp predicable when hypothetically supposing that the waste gate valve 77 is fully closed. After the predicted engine torque Tp is estimated, the processing proceeds to step S20.

In step S20, the variable system compares the predicted engine torque Tp and the target engine torque T (=Td). If the predicted engine torque Tp is determined to be lower than the target engine torque T, the variable system determines that the waste gate valve 77 does not have to be opened, and then the processing proceeds to step S18 and the same control steps are repeated. On the other hand, if the predicted engine torque Tp is determined to be higher than the target engine torque T, the processing proceeds to step S21.

In step S21, since the predicted engine torque Tp is higher than the target engine torque T, the variable system calculates a waste gate target valve-opening amount θw to reduce this predicted engine torque Tp to the maximum engine torque Td. In step S22, the variable system controls the waste gate valve 77 to drive it to the target valve-opening amount θw. After completion of the control of the waste gate valve 77, the processing proceeds to step S23.

In steps S23 and S24, the variable system detects the pressure in the intake pipe (the boost pressure) again, and calculates an actual engine torque Tac based thereon. After an end of the calculation of the actual engine torque Tac, the processing proceeds to step S25.

In step S25, the variable system determines whether the actual engine torque Tac matches the maximum engine torque Td (within a predetermined range). If the actual engine torque Tac is determined to match the maximum engine torque Td by this determination, the processing proceeds to RETURN, assuming that the actual engine torque Tac reaches the maximum engine torque Td. On the other hand, if the actual engine torque Tac does not match the maximum engine torque Td (if there is a certain degree of difference therebetween), the processing returns to step S18 again, from which the variable system performs similar control steps.

In the present embodiment, the variable system uses the waste gate valve 77, but the high mechanical expansion ratio εEd and the closing timing IVCdad of the intake valve advanced from the intake bottom dead center BDC allow the variable system to achieve the improvement of the thermal efficiency (=the improvement of the fuel economy) and also reduce the temperature of the exhaust gas to prevent or reduce the thermal damage on the exhaust-system component even when reducing the engine torque to the predetermined maximum engine torque by opening the waste gate valve 77.

Further, the low lift characteristic L1 set as the lift characteristic of the intake valve contributes to the reduction in the absolute amount of the exhaust gas amount and thus the reduction in the absolute amount of the exhaust gas passing through the waste gate valve 77, thereby succeeding in further preventing or reducing the thermal damage on the exhaust-system component caused by the wake with the aid of the synergy effect thereof with the effect of reducing the temperature of the exhaust gas due to the high mechanical expansion ratio εEd.

### Third Embodiment

The second embodiment proposes the example of a so-called “early-closing Miller cycle”, which reduces the pump loss by advancing the closing timing IVC from the intake bottom dead center BDC with respect to the closing timings IVCa to IVCb of the intake valve in the low load region.

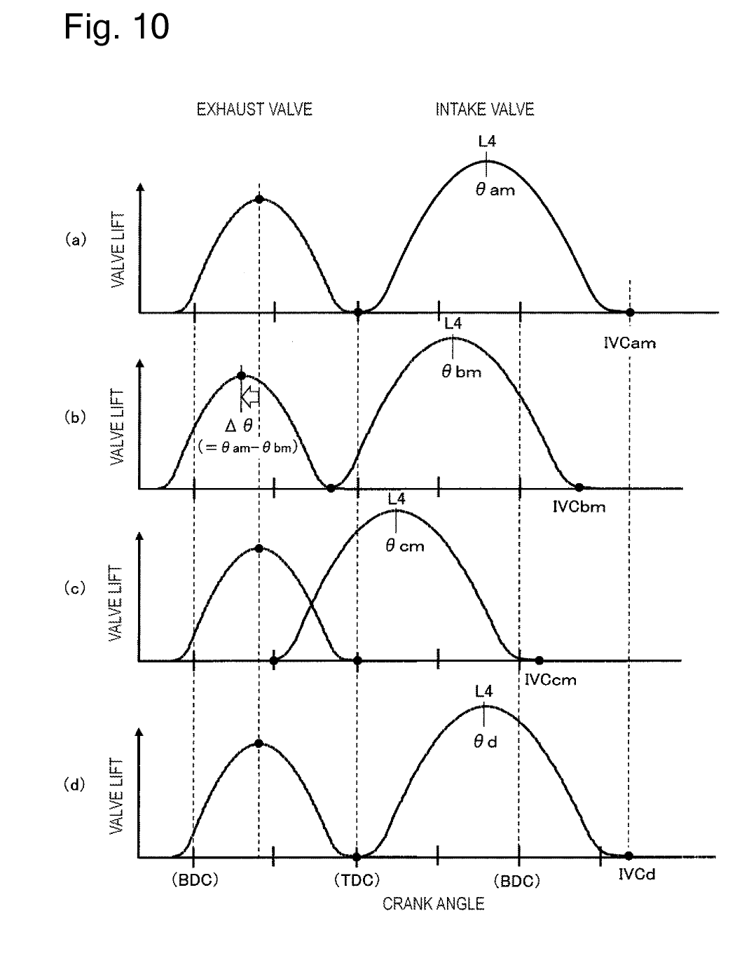

On the other hand, the third embodiment proposes an example of a so-called “late-closing Miller cycle”, which reduces the pump loss by retarding the closing timing IVC from the intake bottom dead center BDC as indicated by the closing timing IVCd similarly to the first embodiment even in the low load region, and an example of a different variable actuation valve configuration from the first embodiment. The present embodiment employing this “late-closing Miller cycle” will be described with reference to FIGS. 10(a) to 10(d).

The lift characteristic is controlled with use of the first variable actuation valve mechanism 1 in the first embodiment, but the lift amount characteristic of the intake valve is only the maximum lift characteristic L4 and is controlled with use of the second variable actuation valve mechanism 2 (the intake VTC) without use of the first variable actuation valve mechanism 1 (the intake VEL) in the present embodiment. A third variable actuation valve mechanism (an exhaust VTC), which is the same mechanism as the second variable actuation valve mechanism 2, is also used on the exhaust side in the present embodiment.

Now, as illustrated in FIG. 10(d), the lift characteristic at the maximum engine torque Td is the same as the lift characteristic illustrated in FIG. 7(d) according to the first embodiment. More specifically, the lift characteristic of the intake valve is set to the maximum lift characteristic L4 with the central phase angle set to the phase angle θd and the closing timing placed at the closing timing IVCd of the intake valve. Similarly, the lift characteristic, the opening and closing timings, and the central phase angle on the exhaust side are also the same as the valve characteristic of the exhaust valve illustrated in FIG. 7(d) according to the first embodiment. Therefore, similarly to the first embodiment, the present embodiment allows the variable system to achieve the improvement of the thermal efficiency (=the improvement of the fuel economy) and also reduce the temperature of the exhaust gas to thus prevent or reduce the thermal damage on the exhaust-system component around the maximum engine torque Td.

Next, the valve lift characteristic at the engine torque Ta in the low load region will be described. As illustrated in FIG. 10(a), the valve characteristics of the intake valve and the exhaust valve approximately match the valve characteristics at the maximum engine torque Td illustrated in FIG. 10(d). In other words, a closing timing IVCam of the intake valve illustrated in FIG. 10(a) approximately matches the closing timing IVCd illustrated in FIG. 10(d), and the variable system employs the “late-closing Miller cycle” as described above, thereby reducing the engine torque to the low engine torque Ta and also reducing the pump loss to improve the fuel economy. Further, a valve overlap is also approximately “0”, and instable combustion due to residual gas can be prevented or reduced.

Next, after the engine torque increases to the engine torque Tb, the variable system operates so as to reduce the pump loss to improve the fuel economy as much as possible while securing the engine torque Tb by advancing the closing timing to a closing timing IVCbm, which is a slightly late timing, as illustrated in FIG. 10(b). Now, the central phase angle of the exhaust valve is controlled by the third variable actuation valve in an advance-angle direction by a difference LB compared to when the engine torque is the engine torque Ta.

This difference Δθ is expressed as “θam−θbm”, i.e., expressed as “IVCam−IVCbm”, and the valve overlap is kept approximately at “0”. Therefore, the present embodiment allows the variable system to reduce the residual gas amount in the cylinder, thereby preventing or reducing a change in the combustion and unstable combustion similarly to when the engine torque is the engine torque Ta.

When the accelerator pedal is further pressed, the closing timing IVC of the intake valve is advanced to the closing timing IVCcm to be placed closer toward the intake bottom dead center BDC side, by which the charging efficiency is being enhanced, as illustrated in FIG. 10(c). This closing timing IVCcm approximately matches IVCc illustrated in FIG. 7(c) according to the first embodiment, and is a closing timing IVC that can enhance the charging efficiency. On the other hand, the exhaust valve is controlled to return to an original position by being shifted toward the retard-angle side by Δθ in an opposite manner compared to FIG. 10(b). Now, as illustrated in FIG. 10(c), one possible consequence therefrom is that a large amount of residual gas may undesirably remain in the cylinder to make the combustion state instable, but the combustion state can be improved in the following manner.

That is, the opening timing of the exhaust valve is retarded, and the central phase of the valve overlap is advanced. This means that the valve overlap timing comes in a relatively short time after the exhaust valve is opened. More specifically, the exhaust valve is opened and the pressure increases in an exhaust pipe around the exhaust valve, and a high pressure wave thereof moves to the wake to be reflected at an end portion of the exhaust pipe to return to around the exhaust valve again. The overlap timing comes before this pressure wave returns, which prevents or reduces introduction of the high-pressure exhaust gas into the cylinder via the exhaust valve as the residual gas, thereby allowing the variable system to prevent or reduce the instable combustion.

Further, maximally pressing the accelerator pedal causes the throttle valve to be fully opened, the charging efficiency to further increase, and the exhaust gas amount to further increases. Therefore, the boost pressure of the turbocharger (the pressure in the intake pipe) is boosted to significantly increase, but the closing timing IVC is retarded to the closing timing IVCd as illustrated in FIG. 10(d) and the mechanical expansion ratio is controlled to a high mechanical expansion ratio εEd, which allows the variable system to keep the engine torque at the maximum engine torque Td, while achieving the improvement of the thermal efficiency (=the improvement of the fuel economy) and also reducing the temperature of the exhaust gas to prevent or reduce the thermal damage on the exhaust-system component similarly to the first embodiment.

### Fourth Embodiment

The variable compression ratio mechanism 3 used in the first to third embodiments is configured as the mechanism that completes one cycle based on the crank angle of 360 degrees, and therefore is configured in such a manner that the piston position at the compression top dead center and the piston position at the exhaust top dead center coincide with each other in principle. Further, for the same reason, the piston position at the intake bottom dead center and the piston position at the expansion bottom dead center also coincide with each other. Therefore, the mechanical compression ratio εC and the mechanical expansion ratio also EE also match each other in principle.

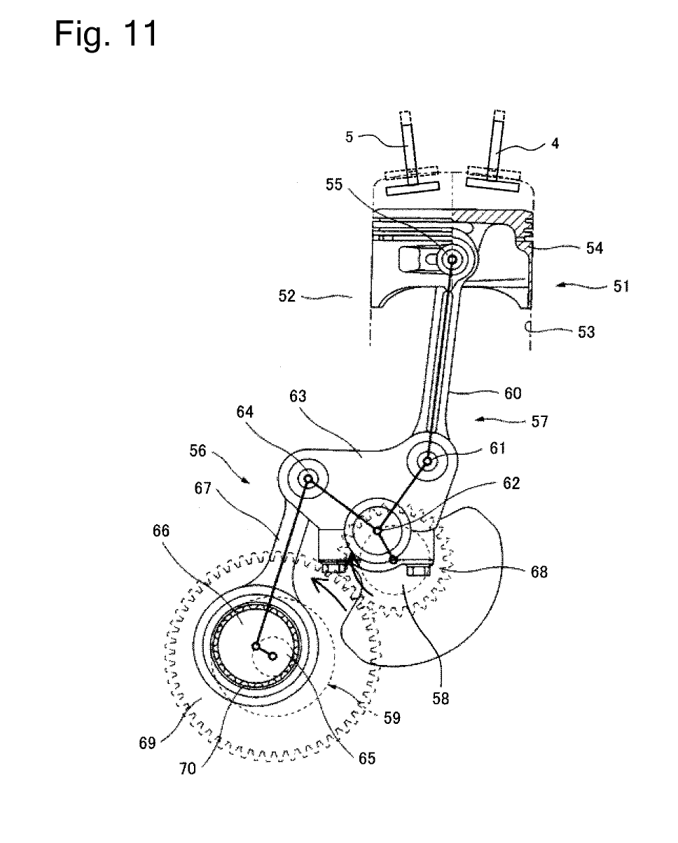

On the other hand, the variable compression ratio mechanism 3 used in the fourth embodiment is configured as a mechanism that completes one cycle based on a crank angle of 720 degrees, and therefore can control the mechanical compression ratio εC and the mechanical expansion ratio εE so as to make them different from each other. A schematic configuration of this differently configured variable compression ratio mechanism 3 will be briefly described with reference to FIG. 11. A detailed description thereof is disclosed in “Japanese Patent Application Public Disclosure No. 2016-017489” previously applied by the present applicant, and therefore might be understood well by referring to this patent literature.

An internal combustion engine 51 includes a piston 54 and a crankshaft 58. The piston 54 reciprocates vertically along a cylinder bore 53 formed inside a cylinder block 52. The crankshaft 58 is rotationally driven by the vertical movement of the piston 54 via a piston pin 55 and a link mechanism 57 of a piston position change mechanism 56. A space defined between a crown surface of the piston 54 and a combustion chamber boundary line indicated by an alternate long and short dash line above this crown surface is the cylinder inner volume (a volume in a combustion chamber).

The piston position change mechanism 56 includes the link mechanism 57, a link posture change mechanism 59, and the like. The link mechanism 57 includes a plurality of link. The link posture change mechanism 59 changes a posture of the link mechanism 57. The link mechanism 57 includes an upper link 60, a lower link 63, and a control link 67. The upper link 60 is coupled with the piston 54 via the piston pin 55. The lower link 63 is swingably coupled with the upper link 7 via a first coupling pin 61, and is also rotatably coupled with a crank pin 62 of the crankshaft 58. The control link 67 is swingably coupled with the lower link 63 via a second coupling pin 64, and is also rotatably coupled with an eccentric cam portion 66 of a control shaft 65.

Further, while a small-diameter first gear wheel 68, which is a driving rotational member, is fixed to a front end portion of the crankshaft 58, a large-diameter second gear wheel 69, which is a driven rotational member, is provided on a front end portion side of the control shaft 65, and the piston position change mechanism 56 is configured in such a manner that the first gear wheel 68 and the second gear wheel 69 are meshed with each other to allow a rotational force of the crankshaft 58 to be transmitted to the control shaft 65 via the link posture change mechanism 59.

The first gear wheel 68 has an outer diameter approximately half an outer diameter of the second gear wheel 69, and therefore a rotational speed of the crankshaft 58 is arranged so as to be transmitted to the control shaft 65 while being reduced to a half angler speed due to a difference between the outer diameters of the first gear wheel 68 and the second gear wheel 69. The control shaft 65 is configured in such a manner that a phase thereof relative to the second gear wheel 69 is changed, i.e., a relative rotational phase with respect to the crankshaft 58 is changed by the link posture change mechanism 59.

The crankshaft 58 and the control shaft 65 are each rotatably supported by common two bearing members provided on the cylinder block in front of and behind them. Further, the eccentric cam portion 66 is rotatably coupled with a large-diameter portion formed at a lower end portion of the control link 67 via a needle bearing 70.

The variable compression ratio mechanism 3 configured in this manner can control the mechanical compression ratio εC and the mechanical expansion ratio εE so as to make them different from each other as discussed in the above-described patent literature “Japanese Patent Application Public Disclosure No. 2016-017489”. In the present embodiment, the variable system achieves the improvement of the thermal efficiency and also reduce the temperature of the exhaust gas to prevent or reduce the thermal damage on the exhaust-system component by increasing the mechanical expansion ratio εE around the maximum engine torque with use of this characteristic.

Next, specific control characteristics of the first variable actuation valve mechanism 1, the second variable actuation valve mechanism 2, and the variable compression ratio mechanism 3 illustrated in FIG. 11 will be described.

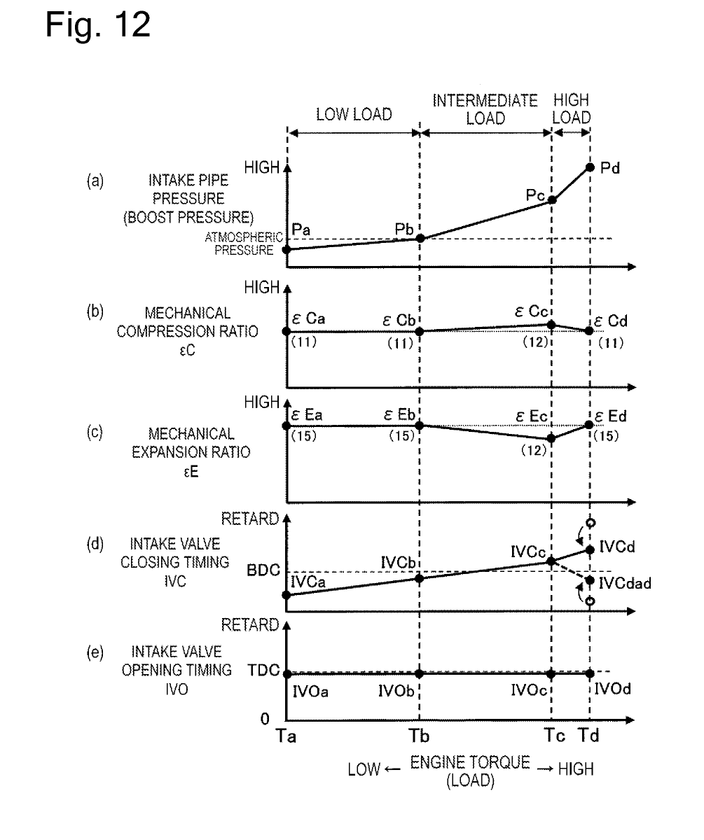

FIGS. 12(a) to 12(e) each illustrate the control characteristic of the control parameter for each engine torque region similar to FIGS. 6(a) to 6(e) according to the first embodiment. In the present embodiment, the first variable actuation valve mechanism 1, the second variable actuation valve mechanism 2, and the variable compression ratio mechanism 3 are controlled so as to be able to acquire this control characteristic of the control parameter. Now, the boost pressure and the control characteristics of the closing timing IVC of the intake valve and the opening timing IVO of the intake valve are similar to the first embodiment, and therefore descriptions thereof will be omitted here.

In the present embodiment, as illustrated in FIGS. 12(a) to 12(e), the variable system employs a control characteristic in which the mechanical compression ratio εC and the mechanical expansion ratio εE are set to “11” and “15”, respectively, in the low load region, employs a control characteristic in which the mechanical compression ratio εC increases like from “11” to “12” and the mechanical expansion ratio FE reduces like from “15” to “12” according to the increase in the engine torque in the intermediate load region, and employs a control characteristic in which the mechanical compression ratio εC reduces like from “12” to “11” and the mechanical expansion ratio εE increases like from “12” to “15” according to the increase in the engine torque in the high load region.

In the low load region, the mechanical compression ratio εC and the mechanical expansion ratio εE are set to control characteristics kept approximately constant even when the engine torque increases. More specifically, the mechanical expansion ratio εE is set to a high ratio “15”, and the mechanical compression ratio εC is set to a low ratio “11”. This allows the variable system to increase the combustion work by setting the mechanical expansion ratio εE to the high value “15”, and, further, to reduce the gas temperature at the compression top dead center to reduce a cooling loss by setting the mechanical compression ratio εC to the slightly low value “11”, thereby succeeding in enhancing the thermal efficiency to further improve the fuel economy.

When the accelerator pedal is further pressed and enters the intermediate load region, the control characteristic is gradually changed from the control characteristic in the low load region to the control characteristic in the intermediate load region, and the mechanical expansion ratio εE is changed from “15” to “12” and the mechanical compression ratio εC is changed from “11” to “12” at the engine torque Tc. The mechanical expansion ratio EE and the mechanical compression ratio εC are set to “9” at the engine torque Tc in the first embodiment, but are set to “12 and thus have a characteristic facilitating an increase in the engine torque with an intake ratio (an intake stroke) also increasing in the present embodiment.

Then, when the accelerator pedal is further pressed and enters the high load region, the control characteristic is gradually changed from the control characteristic in the intermediate load region to the control characteristic in the high load region. When the engine torque reaches around the maximum engine torque Td set to guarantee the durability of the driving system and the like, the mechanical expansion ratio εE is changed and set from “12” to “15” and the mechanical compression ratio εC is changed and set from “12” to “11”. This control characteristic sets the high mechanical expansion ratio εE=“15” similarly to the first embodiment, and can sufficiently reduce the temperature of the exhaust gas.

On the other hand, the value of the mechanical compression ratio εC reduces from “12” to “11”, and also falls below the mechanical expansion ratio εE=“15” while reducing to the mechanical compression ratio εC=11. In this manner, the mechanical compression ratio εC falls below the mechanical compression ratio εC=15 set in the first embodiment. This means a reduction in the effective compression ratio (the actual compression ratio), and therefore means a reduction in an amount by which the closing timing IVC of the intake valve is retarded or advanced from the intake bottom dead center BDC, i.e., the effective compression ratio reduces according to the closing timing IVC to avoid the knocking at the maximum engine torque Td.

Therefore, as illustrated in FIGS. 12(a) to 12(e), the closing timing IVCd according to the present embodiment can be retarded by a smaller amount compared to the closing timing IVCd according to the first embodiment that is indicated by a “circle” mark. Similarly, the closing timing IVCdad according to the present embodiment can be advanced by a smaller amount compared to the closing timing IVCdad according to the second embodiment that is indicated by a “circle” mark.

In the above-described first to fourth embodiments, the maximum engine torque Td set to guarantee the durability of the driving system, the internal combustion engine, and the like is assumed to be kept approximately constant regardless of the change in the number of rotations, but may be set so as to be changed according to the change in the number of rotations. Further, the maximum engine torque Td may be set in consideration of durability of the engine component itself such as the piston in the internal combustion engine, a limitation on a vibration of the internal combustion engine, and/or the like instead of being set to guarantee the durability of the driving system.

Further, the variable actuation valve mechanism has been described based on the example including both the lift/actuation angle variable mechanism for controlling the valve lift and the actuation angle of the intake valve and the phase variable mechanism for controlling the lift central phase angle of the intake valve, but may be any type of mechanism that can change the closing timing IVC of the intake valve. Similarly, the variable compression ratio mechanism that controls the mechanical compression ratio εC and the mechanical expansion ratio εE in the cylinder has been described referring to the two methods, but may employ any method that can change the mechanical expansion ratio E.

In the above-described manner, according to the present invention, the variable system is configured to space the closing timing of the intake valve apart from the intake bottom dead center by the variable actuation valve mechanism and also increase the mechanical expansion ratio by the variable compression ratio mechanism when the engine torque increases to around the maximum engine torque.

According thereto, the variable system can reduce the effective compression ratio to enhance the knocking resistance capability by spacing the closing timing of the intake valve apart from the intake bottom dead center, and, further, achieve the improvement of the thermal efficiency (=the improvement of the fuel economy) and also reduce the temperature of the exhaust gas to prevent or reduce the thermal damage on the exhaust-system component by increasing the mechanical expansion ratio εE, around the maximum engine torque.

Further, in the following description, technical ideas recognizable from the above-described embodiments will be described.

A variable system of an internal combustion engine includes a control unit configured to control a variable actuation valve mechanism configured to control a closing timing of an intake valve and a variable compression ratio mechanism configured to control a mechanical compression ratio and a mechanical expansion ratio. The control unit is configured to control the variable actuation valve mechanism and the variable compression ratio mechanism at least in a first region in which an engine torque is low, a second region in which the engine torque is an intermediate level, and a third region in which the engine torque is high. Further, the control unit keeps the mechanical expansion ratio at a first mechanical expansion ratio and also sets the closing timing of the intake valve to an advance-angle side advanced from an intake bottom dead center in the first region. The control unit reduces the first mechanical expansion ratio to a second mechanical expansion ratio according to an increase in the engine torque and also sets the closing timing of the intake valve from the advance-angle side to a retard-angle side of the intake bottom dead center according to the increase in the engine torque in the second region. The control unit increases the second mechanical expansion ratio to a third mechanical expansion ratio according to the increase in the engine torque and also sets the closing timing of the intake valve to a retard-angle side further retarded from the retard-angle side in the case of the second region according to the increase in the engine torque in the third region.

Further, another aspect is a method for controlling a variable system of an internal combustion engine including a control unit configured to control a variable actuation valve mechanism configured to control a closing timing of an intake valve and a variable compression ratio mechanism configured to control a mechanical compression ratio and a mechanical expansion ratio. The control method includes setting the closing timing of the intake valve to an advance-angle side advanced from an intake bottom dead center when an engine torque is in a state of a low engine torque, setting the closing timing of the intake valve to a retard-angle side retarded from the intake bottom dead center and also setting the mechanical compression ratio and the mechanical expansion ratio to a first value when the engine torque is in a state of a maximum engine torque, and setting the closing timing of the intake valve to the closing timing between the low engine torque and the maximum engine torque and also setting the mechanical compression ratio and the mechanical expansion ratio to a second value smaller than the first value when the engine torque is in a state between the low engine torque and the maximum engine torque.

The present invention is not limited to the above-described embodiments, and includes various modification examples. For example, the above-described embodiments have been described in detail to facilitate better understanding of the present invention, and are not necessarily limited to the configurations including all of the described features. Further, a part of the configuration of some embodiment can be replaced with the configuration of another embodiment. Further, some embodiment can also be implemented with a configuration of another embodiment added to the configuration of this embodiment. Further, each of the embodiments can also be implemented with another configuration added, deleted, or replaced with respect to a part of the configuration of this embodiment.

The present application claims priority under the Paris Convention to Japanese Patent Application No. 2016-222180 filed on Nov. 15, 2016. The entire disclosure of Japanese Patent Application No. 2016-222180 filed on Nov. 15, 2016 including the specification, the claims, the drawings, and the abstract is incorporated herein by reference in its entirety.

### REFERENCE SIGN LIST

01 piston
02 crankshaft
03 connecting rod
04 combustion chamber
05 ignition plug
1 first variable actuation valve mechanism
2 second variable actuation valve mechanism
3 variable compression ratio mechanism
70 turbocharger
71 compressor
73 turbine
77 waste gate valve

1. A variable system of an internal combustion engine:
wherein this variable system of the internal combustion engine includes a control unit;
wherein the control unit controls a variable actuation valve mechanism configured to adjust a closing timing of an intake valve and a variable compression ratio mechanism configured to adjust a mechanical compression ratio and a mechanical expansion ratio; and
wherein the control unit includes
an intake valve closing timing control unit configured to shift the closing timing of the intake valve to an advance-angle side or a retard-angle side advanced or retarded from an intake bottom dead center by the variable actuation valve mechanism when an engine torque is around a maximum engine torque, and
a mechanical expansion ratio control unit configured to increase the mechanical expansion ratio by the variable compression ratio mechanism according to an increase in the engine torque.

2. The variable system of the internal combustion engine according to claim 1, wherein the variable actuation valve mechanism is a phase angle variable mechanism configured to control a central phase angle of a valve characteristic of the intake valve, and
wherein the variable compression ratio mechanism is a piston stroke variable mechanism configured to control a piston stroke to adjust the mechanical compression ratio and the mechanical expansion ratio to the same value as each other.

3. The variable system of the internal combustion engine according to claim 2, wherein the variable actuation valve mechanism includes the phase angle variable mechanism and a lift/actuation angle variable mechanism configured to control a lift and an actuation angle of the intake valve.

4. The variable system of the internal combustion engine according to claim 3, wherein the lift/actuation angle variable mechanism and the phase angle variable mechanism change the lift and the actuation angle of the intake valve and also change the closing timing of the intake valve, and
wherein the intake valve closing timing control unit increases the lift and the actuation angle of the intake valve and also sets the closing timing of the intake valve from the advance-angle side advanced from the intake bottom dead center to the retard-angle side retarded from the intake bottom dead center as the engine torque increases from a state of a low engine torque to a state of the maximum engine torque.

5. The variable system of the internal combustion engine according to claim 4, wherein the mechanical expansion ratio control unit sets the mechanical compression ratio and the mechanical expansion ratio to a first value when the engine torque is in the state of the low engine torque or the state of the maximum engine torque, and sets the mechanical compression ratio and the mechanical expansion ratio to a second value smaller than the first value when the engine torque is in a state between the low engine torque and the maximum engine torque.

6. The variable system of the internal combustion engine according to claim 2, wherein the phase angle variable mechanism changes the closing timing of the intake valve without changing the valve characteristic of the intake valve, and
wherein the intake valve closing timing control unit sets the closing timing of the intake valve to the retard-angle side retarded from the intake bottom dead center when the engine torque is in a state of a low engine torque or a state of the maximum engine torque, and sets the closing timing of the intake valve to between closing timings at the low engine torque and the maximum engine torque when the engine torque is in a state between the low engine torque and the maximum engine torque.

7. The variable system of the internal combustion engine according to claim 6, wherein the mechanical expansion ratio control unit sets the mechanical compression ratio and the mechanical expansion ratio to a first value when the engine torque is in the state of the low engine torque or the state of the maximum engine torque, and sets the mechanical compression ratio and the mechanical expansion ratio to a second value smaller than the first value when the engine torque is in the state between the low engine torque and the maximum engine torque.

8. The variable system of the internal combustion engine according to claim 1, wherein the variable actuation valve mechanism includes a phase angle variable mechanism configured to control a central phase angle of a valve characteristic of the intake valve, and a lift/actuation angle variable mechanism configured to control a lift and an actuation angle of the intake valve, and
wherein the variable compression ratio mechanism is a piston stroke variable mechanism configured to variably control a piston stroke to adjust the mechanical compression ratio and the mechanical expansion ratio to different values from each other.

9. The variable system of the internal combustion engine according to claim 8, wherein the lift/actuation angle variable mechanism and the phase angle variable mechanism change the lift and the actuation angle of the intake valve and also change the closing timing of the intake valve,
wherein the intake valve closing timing control unit increases the lift and the actuation angle of the intake valve and also sets the closing timing of the intake valve from the advance-angle side advanced from the intake bottom dead center to the retard-angle side retarded from the intake bottom dead center as the engine torque increases from a state of a low engine torque to a state of the maximum engine torque, and
wherein the mechanical expansion ratio control unit sets the mechanical expression ratio to a higher ratio compared to the mechanical compression ratio in the state of the maximum engine torque.

10. The variable system of the internal combustion engine according to claim 9, wherein the mechanical expansion ratio control unit sets the mechanical expansion ratio to a higher ratio than the mechanical compression ratio regardless of a strength of the engine torque,
wherein the mechanical expansion ratio control unit sets the mechanical compression ratio to a first value when the engine torque is in the state of the low engine torque or the state of the maximum engine torque, and also sets the mechanical compression ratio to a second value larger than the first value when the engine torque is in a state between the low engine torque and the maximum engine torque, and
wherein the mechanical expansion ratio control unit sets the mechanical expansion ratio to a third value when the engine torque is in the state of the low engine torque or the state of the maximum engine torque, and also sets the mechanical expansion ratio to a fourth value smaller than the third value when the engine torque is in the state between the low engine torque and the maximum engine torque.

11. The variable system of the internal combustion engine according to claim 1, wherein the internal engine includes a turbocharger.

12. The variable system of the internal combustion engine according to claim 11, wherein the turbocharger is a turbocharger including a waste gate valve.

13. The variable system of the internal combustion engine according to claim 11, wherein the turbocharger is a turbocharger including no waste gate valve.

14. The variable system of the internal combustion engine according to claim 1, wherein the control unit sets the engine torque to the maximum engine torque by setting a throttle valve to an approximately fully opened state.

15. A variable system of an internal combustion engine:
wherein the variable system is used for an internal combustion engine including a turbocharger equipped with a waste gate valve, a variable actuation valve mechanism configured to control a closing timing of an intake valve, and a variable compression ratio mechanism configured to control a mechanical compression ratio and a mechanical expansion ratio;
wherein the variable system further includes a control unit configured to control the waste gate valve, the variable actuation valve mechanism, and the variable compression ratio mechanism;
wherein the control unit controls the variable actuation valve mechanism and the variable compression ratio mechanism at least in a region where an engine torque is an intermediate level and a region where the engine torque is higher than the region of the intermediate level; and
wherein, further, the control unit reduces the mechanical expansion ratio to a predetermined mechanical expansion ratio according to an increase in the engine torque and also sets the closing timing of the intake valve from an advance-angle side to a retard-angle side of an intake bottom dead center according to the increase in the engine torque in the region where the engine torque is the intermediate level, and increases the predetermined mechanical expansion ratio and controls the waste control valve to open it according to the increase in the engine torque and also sets the closing timing of the intake valve to the advance-angle side advanced from the intake bottom dead center according to the increase in the engine torque in the region where the engine torque is higher than the region of the intermediate level.

16. A method for controlling a variable system of an internal combustion engine, the variable system including a control unit configure to control
a variable actuation valve mechanism configured to control a closing timing of an intake valve and
a variable compression ratio mechanism configured to control a mechanical compression ratio and a mechanical expansion ratio, the control method comprising:
keeping the mechanical expansion ratio at a first mechanical expansion ratio and also setting the closing timing of the intake valve to an advance-angle side advanced from an intake bottom dead center in a first region where an engine torque is low;
reducing the first mechanical expansion ratio to a second mechanical expansion ratio according to the increase in the engine torque and also setting the closing timing of the intake valve from the advance-angle side to a retard-angle side of the intake bottom dead center according to the increase in the engine torque in a second region where the engine torque is an intermediate level; and
increasing the second mechanical expansion ratio to a third mechanical expansion ratio according to the increase in the engine torque and also setting the closing timing of the intake valve to a retard-angle side further retarded from the retard-angle side in the case of the second region according to the increase in the engine torque in a third region where the engine torque is high.
